(19) United States
(12) Patent Application Publication
(10) Pub. No.: US 2008/0225837 A1
(43) Pub. Date: Sep. 18, 2008

(54) System and Method for Multi-Layer Distributed Switching

(75) Inventor: Jeremy Ray Brown, Orem, UT (US)

Correspondence Address: HAYNES AND BOONE, LLP, 901 Main Street, Suite 3100, Dallas, TX, 75202, US

(73) Assignee: NOVELL, INC., Provo, UT (US)

(21) Appl. No.: 11/687,545

(22) Filed: Mar. 16, 2007

(51) Int. Cl. H04L 12/50

(52) U.S. Cl. 370/360; 707/E17.032

(57) ABSTRACT

A system and method for multi-layer distributed switching is disclosed. In one embodiment, the distributed switching system comprises an external network connection connected to a plurality of computing nodes such that data signals can be sent to and from the computing nodes. An incoming director module is associated with a first computing node and associates a data signal with a second computing node. There is a request distribution network for distributing data signals among the nodes, a response generator module, and an outgoing director module associated with the second computing node.

### BACKGROUND

A distributed computing system is a group of processing units frequently referred to as “nodes”, which work together to present a unified system to a user. These systems can range from relatively small and simple, such as multi-component single systems, to world-wide and complex, such as some grid computing systems. These systems are usually deployed to improve the speed and/or availability of computing services over that provided by a single processing unit alone. Alternatively, distributed computing systems can be used to achieve desired levels of speed and availability within cost constraints.

Distributed systems can be generally described in terms of how they are designed to take advantage of various computing concepts, including specialization, redundancy, isolation, and parallelism. Different types of systems are distinguished by the tradeoffs made in emphasizing one or more of these attributes and by the ways in which the system deals with the difficulties imposed by distributed computing, such as latency, network faults, and cooperation overhead.

Specialization takes advantage of the separation of tasks within a system. Tasks can be done faster with processing units dedicated and specialized for those tasks. Frequently the gains acquired by using specialized processing units are larger than the time lost by coordinating the work between different processing units.

Redundancy is the opposite side of specialization and it refers to having multiple comparable processing units available for work. If there is a problem with any particular processing unit, other units can be brought in to handle the requests which would have gone to the problem unit. For example, some services are deployed on “clusters,” which are interconnected groups of computers, so that the service can continue even if some of the individual computers go down. The resulting reliability is generally referred to as “high availability” and a distributed system designed to achieve this goal is a high availability system.

Isolation is related to redundancy. Part of the reason distributed systems use redundancy to achieve high availability is because each processing unit can be isolated from the larger system. Intrusions, errors, and security faults can be physically and logically separated from the rest of the system, limiting damage and promoting the continuing availability of the system. Further, distributed systems can be designed so that errors in one node can be prevented from spreading to other nodes.

Parallelism is a characteristic of the computing tasks performed by distributed systems. Tasks that can be split up into many independent subtasks are described as highly parallel or parallelizable. Therefore, it i possible to use the different processing units in a distributed system to work on different parts of the same overall task simultaneously, yielding an overall faster result.

Different distributed systems emphasize these attributes in different ways. Regardless of the architecture of the distributed system it is frequently useful to address a distributed system as a single entity, encapsulating the distributed system behind a single coherent interface. However, such encapsulation imposes routing requirements on the distributed system; service requests made to the coherent interface must be sent to a processing unit for evaluation.

### SUMMARY

A system and method for multi-layer distributed switching is disclosed. In one embodiment, the distributed switching system comprises an external network connection connected to a plurality of computing nodes such that data signals can be sent to and from the computing nodes. An incoming director module is associated with a first computing node and associates a data signal with a second computing node. There is a request distribution network for distributing data signals among the nodes, a response generator module, and an outgoing director module associated with the second computing node.

### BRIEF DESCRIPTION OF THE DRAWINGS

FIG. 1 illustrates a cluster server system in accordance with one embodiment.

FIG. 2 illustrates a first mode of operation of the nodes of the cluster server system of FIG. 1 in accordance with one embodiment.

FIG. 3 illustrates a first mode of operation of the nodes of the cluster server system of FIG. 1 in accordance with one embodiment.

FIG. 4 is a flowchart showing one embodiment of a combined-mode system.

### DETAILED DESCRIPTION

One embodiment includes a system and method for distributed multi-layer switching in a distributed system. To better illustrate the advantage and features of the embodiments, a particular description of several embodiments will be provided with reference to the attached drawings. These drawings, and other embodiments described herein, only illustrate selected aspects of the embodiments and do not limit the scope thereof.

For the sake of simplicity, the various embodiments will be described using common terms, where applicable. However, the use of common terms does not imply common implementations between embodiments. For example, one embodiment will use the term “node” to refer to a single computer within a distributed system. However, “node” is meant to encompass subclusters in a cluster-of cluster system, virtualized operating systems or compute nodes, specific integrated circuits or chips, software modules, and generally any system capable of computation and communication. Similarly, the term “luster” will be used in some embodiments to refer to a group of nodes providing a high-availability network service. However, “cluster” is meant to encompass distributed systems generally, including but not limited to NUMA systems, grid computing systems, “Beowulf” clusters, failover systems, MPP systems, and other distributed computing architectures.

Further, despite reference to specific features illustrated in the example embodiments, it will nevertheless understood that these features are not essential to all embodiments and no limitation of the scope thereof is thereby intended. Possible alterations, modifications, and applications of the principles described herein such as would occur to one skilled in the art, have been omitted for clarity and brevity; nevertheless, it is understood that such alternations, modifications, and applications are contemplated. Furthermore, some items are shown in a simplified form and inherently include components that are well know in the art. Further still, some items are illustrated as being in direction connection for the sake of simplicity. Despite the apparent direct connection, it is understood that such illustration does not preclude the existence of intermediate components not otherwise illustrated.

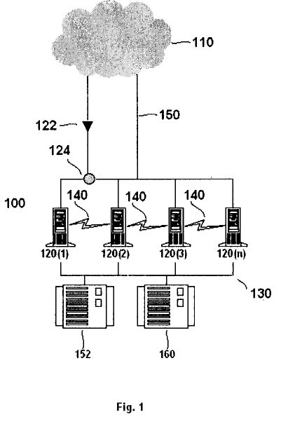

In FIG. 1 is a diagram of a luster server system 100 in accordance with one embodiment. Requests come in from sites in a network cloud 110 to the cluster system 100. Although the luster system 100 appears to requesters as a single virtual server, the system actually comprises multiple nodes 120(1)-120(n). As described more fully below, one of the nodes 120(1)-120(n) acts as an inbound network switch, and other nodes act as outbound network switches.

Clients in the cloud 110 send requests 122 to one or more virtual IP (VIP) addresses 124. In one embodiment, the VIP addresses 124 exist as additional IP addresses to the node's regular host IP address; e.g., a node can be accessed by its VIP address(es) as well a by its regular host address. In a second embodiment the VIP is provided using NAT or a NAT-like system.

The provision of VIP addresses is implementation-dependent: in one embodiment, all services provided by the cluster are associated with the same VIP and port. A second embodiment associate only one VIP address with each network service, but a separate port. A third embodiment uses a separate VIP for each service.

Different virtual servers can be configured for different sets of physical services, such as TCP and UDP services in general. Protocol- or application-specific virtual servers that may be supported include HTTP, FTP, SSL, SSL BRIDGE, SSL TCP, NNTP, SIP, and DNS.

Within the cluster, the nodes 120(1)-120(n) have multiple interconnections. Each node 120(1)-120(n) is able to receive including requests 122. There are also request distribution channels 130 and one or more heartbeat channels 140 between the nodes 120(1)-120(n). One embodiment also includes a backup coordination method, such as a shared quorum partition, to provide communication and coordination services between the nodes. The nodes 120(1)-120(n) also have an outgoing connection 150 to the network cloud 110.

In some embodiments, the nodes 120(1)-120(n) are part of a multi-tier cluster system. In such an embodiment, the nodes 120(1)-120(n) are connected to another cluster system 152 providing other services. Either the nodes 120(1)-120(n) or other second-tier cluster system 152 may additionally be connected to one or more cluster storage systems 160. The cluster systems 152 and 160 may use an embodiment of the clustering system described herein or another clustering system. Further clustering tiers are also contemplated.

For example, one embodiment uses the cluster comprising nodes 120(1)-120(n) as a web serving cluster. Static content for the web clusters is available from a second cluster system, such as a high-availability networked storage system, accessible to the web cluster. Active content for the web cluster is provided by a relational database running on a third cluster system accessible to the nodes 120(1)-120(n). The third (database) cluster system may be backed by a fourth cluster system accessible to the third database cluster system. Services within any, all, or none of the second, third, or fourth cluster systems may use an embodiment of the clustering system described herein.

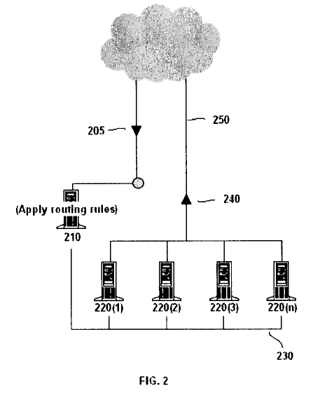

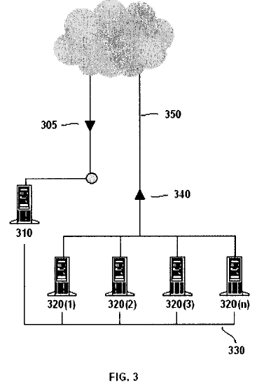

FIG. 2 and FIG. 3 focus on the nodes 120(1)-120(n), showing two different modes of operation. Specifically, among the nodes 120(1)-120(n), one node (e.g., node 120(1)) is designated as an incoming primary for a specific service. FIGS. 2 and 3 show two modes of interaction between the incoming primary and the other nodes, which are generally referred to as “servicing nodes.” In one embodiment, a single node is designated as an incoming primary for all services. In a second embodiment, each service has a different ode that is designated as the incoming primary. While in some embodiments, the incoming primary node may possess additional resources such resources are unnecessary; any node may act as an incoming primary as needed.

In describing certain aspects of each embodiment, certain functions are described as occurring within “modules.” Computing modules may be general-purpose, or they may have dedicated functions such as memory management, program flow, instruction processing, object storage, etc. These modules can be implemented in any way known in the art. For example, in one embodiment a module is implemented in a hardware circuit comprising custom VLSI circuits or gate arrays, of-the-shelf semiconductors such as logic chips, transistors, or other discrete components. One or more of the modules may also be implemented in programmable hardware devices such as field programmable gate arrays, programmable array logic, programmable logic devices or the like.

In another embodiment, one or more of the modules are implemented in software for execution by various types of processors. An identified module of executable code may, for instance, comprise on or more physical or logical blocks of computer instructions that may, for instance, be organized as an object, procedure, or function. Further, the executables of an identified module need not be physically located together, but may comprise disparate instructions stored in different locations that, when joined logically together, comprise the module and achieve the stated purpose for the module. A “module” of executable code could be a single instruction, or many instructions, and may even be distributed over several different code segments, among different programs, and across several memory devices. Similarly, operational data may be identified and illustrated herein within modules, and may be embodied in any suitable form and organized within ay suitable type of data structure. The operational data may be collected as a single data set or may be distributed over different locations including over different storage devices, and may exist, at least partially, merely as electronic signals on a system or network.

Another embodiment uses higher-level components as modules. For example, a module may comprise an entire computer, or group of computers, acting together. A module may also comprise an off-the-shelf or custom program such as a database management system. These higher-level modules may be decomposable into smaller hardware or software modules corresponding to different parts of a software program and identifiable chips (such as memory chips, ASICs, or a CPU) within a computer.

FIG. 2 depicts a first mode of operation (“Mode A”) according to one embodiment. In the servicing nodes, an incoming request 205 associated with a particular service arrives at an incoming primary node 210. The incoming primary node 210 comprises an incoming director module, which selects one of several other cluster nodes 220(1)-220(n) to handle the incoming request 205 and routes the request appropriately.

Various load-balancing algorithms are available to determine to which node 220(1)-220(n) the incoming request 205 should be sent. Some embodiments allocate requests to load-balance the nodes 220(1)-220(n). For example, one embodiment uses round-robin scheduling, distributing each request sequentially between the nodes. A second embodiment uses weighted round-robin scheduling, in which each request is distributed sequentially between the no des but more requests are distributed to servers with greater capacity. Capacity is determined via a user-assigned weight factor, which is then adjusted up or down by dynamic load information. A third embodiment uses a least-connection algorithm. This distributes more requests to nodes with fewer active connections. A fourth embodiment uses a weighted least-connections algorithm; more requests are distributed to nodes with fewer active connections relative to their capacities. Capacity is indicated by a user-assigned weight, which is then adjusted up or down by dynamic load information.

Other embodiments use information about client requests. For example, a fifth embodiment uses locality-based least-connection scheduling. This algorithm distributes more requests to nodes with fewer active connections relative to their destination IPs. This algorithm may be used for widely-distributed cluster systems. A sixth embodiment uses locality-based least-connection scheduling with replication scheduling, distributing more requests to servers with fewer active connections relative to their destination IPs. The target IP address is mapped to a subset of nodes. Requests are then routed to the service in this subset with the lowest number of connection the nodes for the destination IP are above capacity, a new node for the particular destination IP is provisioned by adding the unmapped or otherwise-mapped node with the least connections from the list of nodes to the subset of nodes available for that destination IP. The most-loaded node is then dropped from the subset to prevent over-replication.

Further embodiments use L4-L7 switching based upon rules as applied to the packet flow. For example, an eighth embodiment uses source hash scheduling, distributing request to the nodes by looking up the source IP in a static hash table. A ninth embodiment distributes requests based upon packet inspection, either by examining additional information put into the packet headers or by processing the protocol information. For example, on embodiment reads the HTTP protocol information and routes according to cookie information sent with each request.

After the incoming director of the primary node 210 determines to which servicing node 220(1)-220(n) the incoming request 205 should be sent, the packets in the incoming request 205 are rewritten to address the selected servicing node 220(1)-220(n) and sent across the request distribution channels 230 to the selected servicing node. The selected servicing node then generates a proper response 240 to the request 205.

After the response 240 is generated, the packets and/or connection information associated with the response are rewritten to refer back to the VIP address, rather than the servicing node address, by an outgoing director associated with the selected servicing node. The response 240 is then sent directly to the client via an outgoing connection 250 of the selected servicing node. The outgoing connection 250 need not be the same connection by which the incoming request 205 was received. In this embodiment, the work of modifying outgoing packets is divided from the packet directing services provided by the incoming primary node and distributed proportionally around the cluster. A second embodiment divides the work of modifying packets between only two nodes. In this embodiment, one of the nodes is designated as an “outgoing primary” and all outbound packet rewriting is handled by the outgoing director module associated with the outgoing primary node. A third embodiment uses multiple incoming and/or outgoing primary nodes, and packet rewriting is switched between the various primaries based on the direction of the packet (incoming or outgoing) and a load balancing algorithm such as those discussed above.

Turning to FIG. 3, the diagram shows a second mode of operation (“Mode B”) according to one embodiment. An incoming request 305 associated with a particular service arrive at the incoming primary node 310. If the incoming request 305 has already been associated with a particular one of the service node 330(1)-330(n), the incoming director of the primary node 31 directs the request to the servicing node without re-application of the rules that led to the original association between the incoming request and the particular servicing node. Rather, the incoming packets are modified as appropriate to send the packets to the servicing node an then routed through the request distribution channels 330 to the correct servicing node 320(1)-320(n). The selected one of the servicing nodes 320(1)-320(n) the generates a proper response 340 to the request 305.

After the response 340 is generated, an outgoing director associated with the selected one of the servicing nodes 320(1)-320(n) modifies the packet comprising the response to point back at the VIP address, rather than the servicing node address. The response 340 is then sent to the client via an outgoing connection 350 of the servicing node. The use of an outgoing primary node as described in FIG. 2 is also contemplated under the mode of operation shown in FIG. 3.

The modes of operation described in FIGS. 2 and 3 are not mutually exclusive. In one embodiment, each initial connection is handled via Mode A and each subsequent connection is handled via Mode B. A second embodiment periodically re-checks the load and operation status of selected serving nodes an switches a connection between modes A and B based upon serving node status. A third embodiment using two incoming primaries directs initial request to a first primary using Mode B. If the first primary experiences a cache miss, the request is forwarded to a second primary using Mode A. After evaluating and deciding on the serving node, the second primary updates the cache on the first primary.

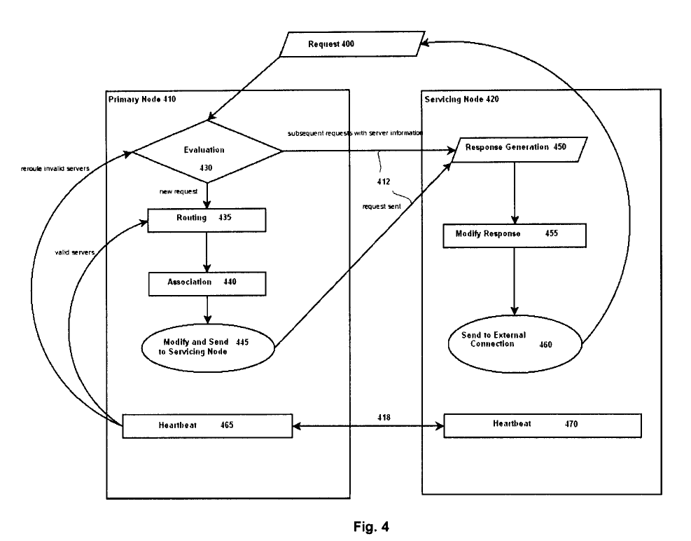

FIG. 4 is a flowchart showing one embodiment of a combined-mode system. This flowchart describes the flow in the context of an idealized cluster system; a Request 400 comes in addressed to a VIP associated with a primary node 410. There are request distribution channels 412 and heartbeat channels 418 connecting primary node 410 with a serving node 420.

In the context of this system represented in FIG. 4, the request 400 comes in to the primary node 410. In step 430, an evaluation module of the primary node 410 examines the request to determine if it has valid and current routing information associated with it. In one embodiment, this step i accomplished by examining the connection data and associating it with the data in a lookup table of current connections. In a second embodiment, this step is accomplished by examining information encoded in the packets or headers of the incoming request. In a third embodiment, this step is accomplished by examining the application protocol information. Any of the information in the packet or in the protocol may be used.

Other embodiments also take into account the state of the cluster and the state of particular servicing nodes. For example, a fourth embodiment uses cluster state information gathered by a cluster monitoring module to determine if particular parts of the cluster are overloaded. If a request is associated with routing information that would send it to an overloaded portion of the cluster, user-configurable rules allow the evaluation module to determine that the routing information is not “current” (i.e., in line with current operating parameters) even if the routing information is “valid” (i.e., it would arrive at an acceptable destination if it were sent on). A fifth embodiment uses a module which evaluates the state of the particular servicing node. If a servicing node is marked as being in a down state, routing information which would send requests to that node is not valid and current.

If there is valid and current routing information associated with the request, execution proceeds to step 445. Otherwise, in step 435 a routing module determines to which servicing node the request should be routed. Any routing algorithm known in the art may be used to accomplish this step, including any or all of the algorithms described in association with FIG. 2. Possible sources of input to the routing module include, but are not limited to, packet and request information, protocol information, geographic connection information, latency information, cluster state information, servicing node state information, and entropy sources.

In step 440 the routing information from step 435 is associated with the request. In one embodiment, this is accomplished by generating an associative table that includes the connection information as the key and the connection information as the value. In a second embodiment this is accomplished by recording a record in a database. In a third embodiment this is accomplished by creating a new routing rule on the fly and loading it into a routing rules engine.

In step 445 the request is modified appropriately to address it to the servicing node addressed by the routing information from step 435. In one embodiment the packet headers are rewritten. In a second embodiment, both the packet headers and the packet contents are rewritten. In a third embodiment, cookies, connection strings, or other protocol information are rewritten. The requests then sent to the servicing node 420 by way of the request distribution channels 412.

In step 450 the request is evaluated at the application level and a response is generated. In step 455, the servicing node rewrites thee connection data to reassociate the response with the VIP as opposed to the particular servicing node. In some embodiments, information associating the request with the servicing node is embedded in the response to assist the primary node in associating a subsequent request with a particular connection.

In step 460, the servicing node puts the rewritten response on an outgoing connection to a remote requesting system. The servicing node may also use the VIP address to negotiate SSL connections directly with the remote requesting system, if necessary.

In parallel with the steps 430-460 described above, the nodes in the cluster heartbeat to each other across the heartbeat channels 418. In one embodiment, in step 465, the primary node sends heartbeat messages to each servicing node; in step 470 the servicing nodes send heartbeat messages back to the primary node. Monitoring modules on both the primary and servicing nodes are then updated with the information. In another embodiment, the order of the heartbeat messages in reverse; the servicing nodes send heartbeat messages first and the primary node sends second. In a third embodiment, the heartbeat messages are all broadcast as opposed to being sent to specific systems; if necessary, a token-passing and timeout scheme is used to keep broadcasts from interfering with each other.

The heartbeat messages and the monitoring modules allow the system substantial flexibility. The primary node uses the heartbeat messages and the monitoring module to stay aware of the status of the servicing nodes. The health and status of individual servicing nodes is taken into account when routing requests, as described in steps 430 and 435.

On the other hand, each non-primary node remains aware of the status of the cluster and is able to perform as a standby primary system. Should a non-primary node fail to receive a heartbeat message within an expected interval, the non-primary attempts to contact the primary node both through the request distribution channels as well as through the shared quorum partition, if present. If the non-primary node is unable to contact the primary, the on-primary initiates a failover and assumes the role of the primary for the cluster. During failover, the non-primary node takes over the VIP addresses serviced by the cluster using ARP spoofing. When the failed node returns to active service, it joins the pool as a non-primary node in the cluster. A node priority or voting scheme is used to prevent split-brain or similar distributed coordination problems.

It is understood that several modifications, changes and substitutions are intended in the foregoing disclosure and in some instances some features of the embodiments will be employed without a corresponding use of other features. Accordingly, it is appropriate that the appended claims be constructed broadly and in a manner consistent with the scope of the embodiments described herein.

1. A distributed switching system comprising:
a plurality of computing nodes operably connected to a first external network connection, wherein data signals can be sent to and from the computing nodes;
a first one of the computing nodes comprising an incoming director module associated with a virtual address, the incoming director module operable to associate a data signal received via the first external network connect with a second one of the computing nodes, wherein the received data signal can be sent between the first computing node and the second computer node via a request distribution channel; and
a response generator module operable to generate a response data signal responsive to the received data signal;
wherein the second computing node comprises an outgoing director module, the outgoing director module operable to associate the response data signal with the virtual address.

2. The system of claim 1 wherein the response generator module is associated with the second computer node.

3. The system of claim 1 wherein the response generator module is associated with a third computer node.

4. The system of claim 1 wherein the system further comprises a heartbeat channel between the plurality of computer nodes.

5. The system of claim 1 further comprising a second external network connection.

6. The system of claim 5 wherein received data signals are received using the first external network connection and response data signals are sent using the second external network connection.

7. The system of claim 1 further comprising a second incoming director module associated with the second computer node.

8. The system of claim 7 wherein the second incoming director module is used if the incoming director module associated with the first computer node is unavailable.

9. A method for distributed switching in a cluster system comprising:
responsive to the receipt of a request addressed to a virtual address, evaluating the request on a first computing node;
modifying the request on the first computing node to associate it with a second computing node;
sending the request to the second computing node;
generating a response at the second computing node;
modifying the response to associate the response with the virtual address; and
sending the response;
wherein the modifying the response does not occur on the first computing node.

10. The method of claim 9 further comprising, subsequent to evaluating the request at the first computing node, making a routing decision at the first computing node.

11. The method of claim 9 wherein the modifying the response occurs at the second computing node.

12. The method of claim 9 wherein the modifying the response occurs at a third computing node.

13. The method of claim 9 further comprising exchanging heartbeat messages between the first and second computing nodes.

14. The method of claim 9 further comprising switching the functions of the first computing node to the second computing node and switching the functions of the second computing node to a third computing node if the first computing node is unavailable.

15. The method of claim 9 further comprising switching the functions of the second computing node to a third computing node if the second computing node is unavailable.

16. A computer program product comprising computer-interpretable instructions on computer-readable media in a cluster system, which when executed:
responsive to the receipt of a request addressed to a virtual address, evaluate the request associated with a first computing node;
modifying the request associated with the first computing node to associate it with a second computing node;
sending the request to the second computing node;
generate a response at the second computing node;
modifying the response to associate the response with the virtual address; and
send the response;
wherein the modifying the response does not occur on the first computing node.

17. The computer program product of claim 16 wherein the response is modified on the second computing node.

18. The computer program product of claim 16 wherein the response is modified on a third computing node.

19. The computer program product of claim 16, further comprising instructions that substitute a third computing node for the second computing node if the second computing node is unavailable.

20. The computer program product of claim 16, further comprising instructions that substitute the second computing node for the first computing node and a third computing node for the second computing node if the first computing node is unavailable.
